(19) United States
(12) Patent Application Publication
(10) Pub. No.: US 2016/0358322 A1
(43) Pub. Date: Dec. 8, 2016

(54) METHOD AND SYSTEM FOR DATA DETECTING OF AN INSTRUMENT

(71) Applicants: STATE GRID CHONGQING ELECTRIC POWER CO. ELECTRIC POWER RESEARCH INSTITUTE, Chongqing (CN); STATE GRID CORPORATION OF CHINA, Beijing City (CN); THE SMARTECH INSTITUTE, Guangdong (CN)

(72) Inventors: Wei Song, Chongqing (CN); Jin FU, Chongqing (CN); Gaolin Wu, Chongqing (CN); Qing Zhou, Chongqing (CN); Bangfei Deng, Chongqing (CN); Lingyun Wan, Chongqing (CN); Qianbo Xiao, Chongqing (CN); Haibing Zhang, Chongqing (CN); Ying Zhang, Chongqing (CN); Wenjie Zhang, Guangdong (CN); Jianfeng Gan, Guangdone (CN); Yuping Wang, Guangdong (CN); Jiaqi Zhang, Guangdong (CN); Haijun Hu, Guangdong (CN); Haipeng Liang, Guangdong (CN)

(21) Appl. No.: 14/894,336

(22) PCT Filed: Aug. 22, 2015
(86) PCT No.: PCT/CN2015/087870

§ 371 Date: Nov. 25, 2015

(30) Foreign Application Priority Data
Dec. 26, 2014 (CN) 201410834445.X

(51) Int. Cl. G06T 7/00

(52) U.S. Cl. CPC G06T 7/004

(57) ABSTRACT

The present application provides a method and a system for detecting data of an instrument. The method comprises controlling rotation of the current data image in a first direction and acquiring current projection values of a pointer of the instrument in a vertical direction from the current data image after acquiring a current data image from an instrument to be read; then, selecting a maximum projection value from the acquired projection values and determining a corresponding position of the pointer of the instrument as a position to be calculated; calculating a first rotation angle required by rotation of the pointer of the instrument to the position to be calculated; substituting the first rotation angle into a pre-stored first calculation formula and calculating a first angle between the pointer of the instrument and the position to be calculated; then, substituting the first angle into a formula of correspondence between a pre-stored angle between the pointer of the instrument and the position to be calculated and instrument graduations to calculate current instrument data of the instrument to be read, thus ensuring the accuracy of the resulting data under various conditions.

### TECHNICAL FIELD

The present invention relates generally to the field of data receiving technology, and more particularly to a method and a system for detecting data of an instrument.

### BACKGROUND OF THE INVENTION

Currently, with the rapid development of image processing technology, it has been applied to data detection of an instrument, thereby solving technical problems of low speed and low accuracy of manual data detection of the instrument. Specifically, after image information of an instrument is obtained, feature information is extracted from the image information of the instrument and the feature is processed using a pre-stored algorithm without human intervention, thereby obtaining displayed data of the instrument and greatly improving the efficiency of data detection of the instrument.

Based on the above ideas, the commonly used methods for data detection of an instrument in the prior art comprise a method for data detection based on Hough transform and a method for data detection based on fitted pointer straight line. The former calculates an instrument reading by measuring an angle between a pointer straight line and zero graduation line, though data of the instrument obtained by this method are accurate, continuous pointer straight line features cannot be obtained when the acquired images of the instrument decline in quality, thus the test results obtained are poor; the latter selects the center and radius of an area where the pointer is located, and then finds a point of intersection of the pointer with a concentric ring within the concentric ring according to a certain step length, and identifies and judges an angle of the pointer with respect to a zero reference line depending on the slope of a line segment formed between points of intersection, thereby obtaining data of the instrument, and despite relatively strong adaptability, this method has low detection accuracy and cannot meet the actual needs. Therefore, there is an urgent need currently for a method for data detection of an instrument with strong adaptability and high detection accuracy.

### SUMMARY OF THE INVENTION

In view of the above, the present invention provides a method and a system for detecting data of an instrument to solve the existing technical problems that the existing method for data detection based on Hough transform can be only applied to scenes with high quality images of the instrument while the method for data detection based on fitted pointer straight line obtains data of the instrument with low accuracy.

To achieve the above object, the present application provides the following technical solutions: a method for detecting data of an instrument, characterized in that said method comprises: acquiring a current data image from an instrument to be read; controlling rotation of the current data image in a first direction and acquiring current projection values of a pointer of the instrument in a vertical direction from the current data image; selecting a maximum projection value from all of acquired current projection values and determining a position where the pointer of the instrument has the maximum projection value in the vertical direction as a position to be calculated; calculating a first rotation angle required by rotation of the pointer of the instrument to the position to be calculated in the first direction; substituting the first rotation angle into a pre-stored first calculation formula and calculating a first angle between the pointer of the instrument and the position to be calculated; and calculating current instrument data of the instrument to be read using correspondence between a pre-stored angle between the pointer of the instrument and the position to be calculated and instrument graduations.

Preferably, the controlling rotation of the current data image in a first direction is particularly controlling rotation of the current data image in a clockwise or counterclockwise direction.

Preferably, the position to be calculated is a horizontal position.

Preferably, the first calculation formula is

$${θ}_{I} = \{ \begin{matrix}{θ}_{A} , & {H}_{A} < \frac{w}{2} \\ {θ}_{A} + 180 , & {H}_{A} > \frac{w}{2}\end{matrix} ;$$

wherein w represents width of the current data image, θ_{I} represents an angle between the pointer of the instrument and a horizontal direction, and θ_{A} represents the first rotation angle.

Preferably, the correspondence between a pre-stored angle between the pointer of the instrument and the position to be calculated and instrument graduations I(θ_{I}) is detailed as:

$$I ( {θ}_{I} ) = \frac{{I}_{max} - {I}_{min}}{{θ}_{max} - {θ}_{min}} {θ}_{I} + \frac{{I}_{min} {θ}_{max} - {I}_{max} {θ}_{min}}{{θ}_{max} - {θ}_{min}} ;$$

wherein Iₘₐₓ represents a maximum graduation of the instrument to be read, θₘₐₓ represents an angle of the pointer of the instrument at a position corresponding to the maximum graduation of the instrument to be read, Iₘᵢₙ represents a minimum graduation of the instrument to be read, and θₘᵢₙ represents an angle of the pointer of the instrument at a position corresponding to the minimum graduation of the instrument to be read.

Preferably, the method further comprises: establishing a two-dimensional coordinate system and aligning a center of the acquired current data image of the instrument to be read with an origin of the two-dimensional coordinate system, prior to the controlling rotation of the current data image in a first direction.

A system for detecting data of an instrument, said system comprising: an acquisition means for acquiring a current data image from an instrument to be read; a rotation control means for controlling rotation of the current data image in a first direction and acquiring current projection values of a pointer of the instrument in a vertical direction from the current data image; a selection means for selecting a maximum projection value from all of acquired current projection values and determining a position where the pointer of the instrument has the maximum projection value in the vertical direction as a position to be calculated; a first calculation means for calculating a first rotation angle required by rotation of the pointer of the instrument to the position to be calculated in the first direction; a second calculation means for substituting the first rotation angle into a pre-stored first calculation formula and calculating a first angle between the pointer of the instrument and the position to be calculated; and a third calculation means for calculating current instrument data of the instrument to be read using correspondence between a pre-stored angle between the pointer of the instrument and the position to be calculated and instrument graduations.

Preferably, the rotation control means comprises: a clockwise rotation control module for controlling rotation of the current data image in a clockwise direction; and a counterclockwise rotation control module for controlling rotation of the current data image in a counterclockwise direction.

Preferably, the system further comprises: a coordinate system establishment means for establishing a two-dimensional coordinate system and aligning a center of the acquired current data image of the instrument to be read with an origin of the two-dimensional coordinate system.

Preferably, the system further comprises: a voice broadcast means for conducting voice broadcast for the current instrument data calculated by the third calculation means.

As can be seen, compared with the prior art, the present application provides a method for detecting data of an instrument. The method comprises controlling rotation of the current data image in a first direction and acquiring current projection values of a pointer of the instrument in a vertical direction from the current data image after acquiring a current data image from an instrument to be read; then, selecting a maximum projection value from the acquired projection values and determining a corresponding position of the pointer of the instrument as a position to be calculated; calculating a first rotation angle required by rotation of the pointer of the instrument to the position to be calculated; substituting the first rotation angle into a pre-stored first calculation formula and calculating a first angle between the pointer of the instrument and the position to be calculated; then, substituting the first angle into a formula of correspondence between a pre-stored angle between the pointer of the instrument and the position to be calculated and instrument graduations to calculate current instrument data of the instrument to be read. As can be seen, according to the present invention, an angle between a pointer of an instrument and a horizontal direction is calculated based on a feature of instrument denotation with a detailed head and a rough tail, to calculate instrument data, thus ensuring the accuracy of the resulting data and avoiding effects of deviation of the straight-line direction calculated by the Hough transform from the actual direction of the pointer of the instrument on instrument readings.

### BRIEF DESCRIPTION OF DRAWINGS

In order to more clearly illustrate technical solutions in the examples of the present invention or in the prior art, the following part will give a simple introduction to drawings required in description about the examples or the prior art. Obviously, drawings in the following description are only examples of the present invention, and those of ordinary skill in the art can also obtain other drawings without creative work based on those provided.

FIG. 1 is a flow chart for an example of a method for detecting data of an instrument according to this invention; and

FIG. 2 is a schematic diagram of the structure of a system for detecting data of an instrument according to this invention.

### DETAILED DESCRIPTION OF EMBODIMENTS

Provided below is a clear and complete description about the technical solutions in examples of the present invention, in conjunction with drawings in the examples of the present invention. Obviously, the described examples are only a part rather than all of the examples of the present invention. All other examples obtained by those of ordinary skill in the art without creative work based on those in the present invention are within the scope of the present invention.

Currently, various image-based instrument reading methods have been proposed at home and abroad. For example, Han hale et al. proposed a method for data detection of an instrument based on improved Hough transform, wherein a binary image is first acquired using an adaptive median filter algorithm and then a pointer straight line angle is extracted using improved Hough transform to detect readings; FANG Ye et al. proposed a substation instrumentation reading recognition algorithm suitable for an outdoor work environment of intelligent substation inspection robots, wherein a dial area of an instrument is extracted through a scale invariant feature transform (SIFT) algorithm, binarization and a backbone treatment are then performed on the dial area, and readings of a pointer straight line angle are extracted through Hough transform; Xiao et al. proposed an automatic instrument reading method based on Hough transform, wherein instrument readings are calculated by measuring an angle between a pointer straight line and a zero graduation straight line, and wherein the above angle method has small angle measurement errors, but it only applies to instruments with uniform graduations; DONG Baotong presented a non-linear instrument reading method, wherein instrument readings are read according to this method in conjunction with a method for recognition of a pointer deflection angle and dial graduations, thus improving the reading accuracy of the traditional angle method, and this algorithm has certain errors itself because this method assumes that the fitted pointer straight line and graduation line are parallel. The pointer straight line may not be a continuous straight line during the process of obtaining the pointer straight line through image processing and the Hough transform will detect multiple straight lines. SUN Fengjie et al. proposed an improved pointer angle recognition algorithm-concentric ring search method, comprising selecting the center and radius of an area where the pointer is located, and then finding a point of intersection of the pointer with a concentric ring within the concentric ring according to a certain step length, and identifying and judging an angle of the pointer with respect to a zero reference line depending on the slope of a line segment formed between points of intersection, and this algorithm has a lower recognition precision than the Hough transform method, but has strong adaptability in actual engineering applications.

Based on the above analysis, the applicant divides the various image feature-based instrument reading methods proposed above into two types: one is a type of methods based on Hough transform, and the other is a type of methods based on fitted pointer straight line. The applicant has found that though instrument readings obtained by the methods based on Hough transform are more accurate, continuous pointer straight line features cannot be obtained when the images of the instrument decline in quality, and the test results by the methods obtained are poor. The methods based on fitted straight line have low detection accuracy and cannot meet the actual needs.

In view of problems present in automatic reading for a substation-pointer-type instrument, the present application provides a method for detecting data of an instrument. The method comprises: controlling rotation of the current data image in a first direction and acquiring current projection values of a pointer of the instrument in a vertical direction from the current data image after acquiring a current data image from an instrument to be read; then, selecting a maximum projection value from the acquired projection values and determining a corresponding position of the pointer of the instrument as a position to be calculated; calculating a first rotation angle required by rotation of the pointer of the instrument to the position to be calculated; substituting the first rotation angle into a pre-stored first calculation formula and calculating a first angle between the pointer of the instrument and the position to be calculated; then, substituting the first angle into a formula of correspondence between a pre-stored angle between the pointer of the instrument and the position to be calculated and instrument graduations to calculate current instrument data of the instrument to be read. As can be seen, according to the present invention, an angle between a pointer of an instrument and a horizontal direction is calculated based on a feature of instrument denotation with a detailed head and a rough tail, to calculate instrument data, thus ensuring the accuracy of the resulting data and avoiding effects of deviation of the straight-line direction calculated by the Hough transform from the actual direction of the pointer of the instrument on instrument readings.

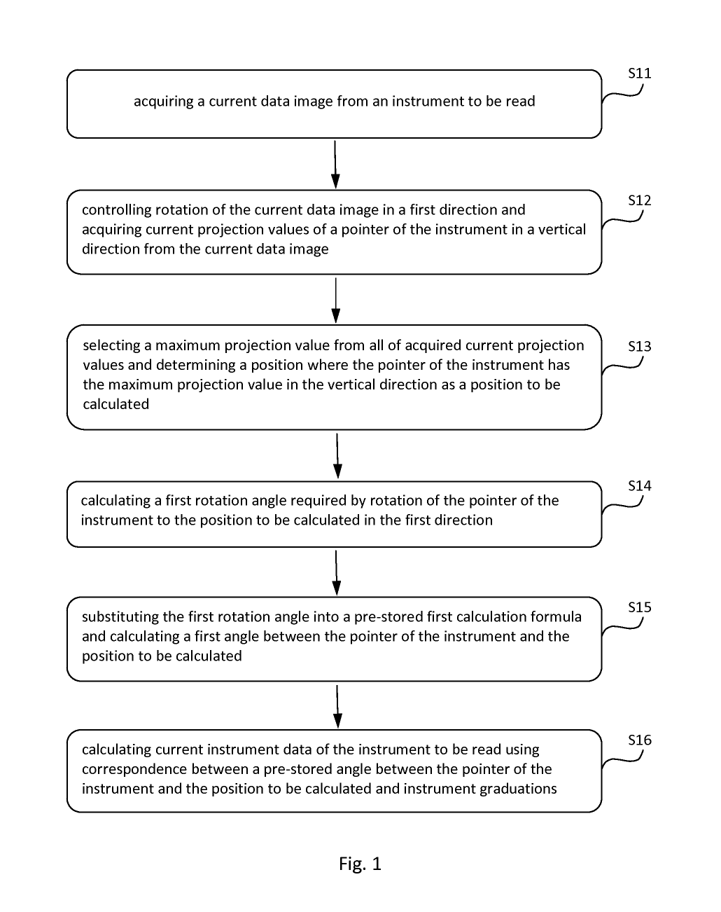

Referring to a flow chart for an example of a method for detecting data of an instrument according to this invention as shown in FIG. 1, the method specifically includes the following steps:

Step S11: acquiring a current data image from an instrument to be read;

Step S12: controlling rotation of the current data image in a first direction and acquiring current projection values of a pointer of the instrument in a vertical direction from the current data image;

In actual applications, it will be possible to control rotation of the current data image in a clockwise or counterclockwise direction and in this regard, specific definitions will not be made in this invention.

Optionally, in this example, a two-dimensional coordinate system, i.e., XY coordinate system can also be established and a center of the acquired current data image of the instrument to be read can be aligned with an origin of the two-dimensional coordinate system, prior to execution of Step S12.

Step 13: selecting a maximum projection value from all of acquired current projection values and determining a position where the pointer of the instrument has the maximum projection value in the vertical direction as a position to be calculated.

In the actual applications of this example, it is found through comparison between current projection values of the pointer of the instrument in the vertical direction at different positions that the corresponding projection value is maximal when the pointer of the instrument is rotated to a horizontal position, and the position to be calculated resulting from Step S23 can be specifically the horizontal position of the pointer of the instrument, namely, a position where the axis X is located.

Step 14: calculating a first rotation angle required by rotation of the pointer of the instrument to the position to be calculated in the first direction;

Step 15: substituting the first rotation angle into a pre-stored first calculation formula and calculating a first angle between the pointer of the instrument and the position to be calculated.

In this example, the first calculation formula is detailed as:

$${θ}_{I} = \{ \begin{matrix}{θ}_{A} , & {H}_{A} < \frac{w}{2} \\ {θ}_{A} + 180 , & {H}_{A} > \frac{w}{2}\end{matrix} , \qquad ( 1 )$$

wherein w represents width of the current data image, θ_{I} represents an angle between the pointer of the instrument and a horizontal direction, and θ_{A} represents the first rotation angle.

In actual applications, since the pointer of the instrument has a fine tip and a thick bottom, when the pointer of the instrument is horizontal (namely, in parallel with the axis X), its projection values in the horizontal direction comprise both top and bottom projection parts with a smaller value at the tip of the pointer and a maximum projection value at the bottom of the pointer. Therefore, directions of the pointer can be judged based on the obtained projection values according to the present invention.

Step S16: calculating current instrument data of the instrument to be read using correspondence between a pre-stored angle between the pointer of the instrument and the position to be calculated and instrument graduations.

In this example, the correspondence between a pre-stored angle between the pointer of the instrument and the position to be calculated and instrument graduations I(θ_{I}) is detailed as:

$$I ( {θ}_{I} ) = \frac{{I}_{max} - {I}_{min}}{{θ}_{max} - {θ}_{min}} {θ}_{I} + \frac{{I}_{min} {θ}_{max} - {I}_{max} {θ}_{min}}{{θ}_{max} - {θ}_{min}} , \qquad ( 2 )$$

wherein Iₘₐₓ represents a maximum graduation of the instrument to be read, θₘₐₓ represents an angle of the pointer of the instrument at a position corresponding to the maximum graduation of the instrument to be read, I^{min} represents a minimum graduation of the instrument to be read, and θₘᵢₙ represents an angle of the pointer of the instrument at a position corresponding to the minimum graduation of the instrument to be read.

To sum up, according to the present invention, an angle between a pointer of an instrument and a horizontal direction is calculated based on a feature of instrument denotation with a detailed head and a rough tail, to calculate instrument data, thus ensuring the accuracy of the resulting data and avoiding effects of deviation of the straight-line direction calculated by the Hough transform from the actual direction of the pointer of the instrument on instrument readings.

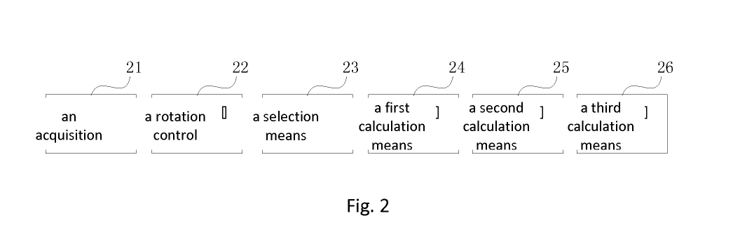

Referring to a schematic diagram of the structure of a system for detecting data of an instrument according to this invention as shown in FIG. 2, the system can include: an acquisition means 21 for acquiring a current data image from an instrument to be read; a rotation control means 22 for controlling rotation of the current data image in a first direction and acquiring current projection values of a pointer of the instrument in a vertical direction from the current data image; optionally, the rotation control means 22 can comprise: a clockwise rotation control module for controlling rotation of the current data image in a clockwise direction; and a counterclockwise rotation control module for controlling rotation of the current data image in a counterclockwise direction.

A selection means 23 for selecting a maximum projection value from all of acquired current projection values and determining a position where the pointer of the instrument has the maximum projection value in the vertical direction as a position to be calculated; a first calculation means 24 for calculating a first rotation angle required by rotation of the pointer of the instrument to the position to be calculated in the first direction; a second calculation means 25 for substituting the first rotation angle into a pre-stored first calculation formula and calculating a first angle between the pointer of the instrument and the position to be calculated, wherein the first calculation formula is detailed as:

$${θ}_{I} = \{ \begin{matrix}{θ}_{A} , & {H}_{A} < \frac{w}{2} \\ {θ}_{A} + 180 , & {H}_{A} > \frac{w}{2}\end{matrix} , \qquad ( 1 )$$

wherein w represents width of the current data image, θ₁ represents an angle between the pointer of the instrument and a horizontal direction, and θ_{A} represents the first rotation angle; and a third calculation means 26 for calculating current instrument data of the instrument to be read using correspondence between a pre-stored angle between the pointer of the instrument and the position to be calculated and instrument graduations, wherein the correspondence I(θ_{I}) between a pre-stored angle between the pointer of the instrument and the position to be calculated and instrument graduations is detailed as:

$$I ( {θ}_{I} ) = \frac{{I}_{max} - {I}_{min}}{{θ}_{max} - {θ}_{min}} {θ}_{I} + \frac{{I}_{min} {θ}_{max} - {I}_{max} {θ}_{min}}{{θ}_{max} - {θ}_{min}} , \qquad ( 2 )$$

wherein Iₘₐₓ represents a maximum graduation of the instrument to be read, θₘₐₓ represents an angle of the pointer of the instrument at a position corresponding to the maximum graduation of the instrument to be read, Iₘᵢₙ represents a minimum graduation of the instrument to be read, and θₘᵢₙ represents an angle of the pointer of the instrument at a position corresponding to the minimum graduation of the instrument to be read.

Optionally, the system for detecting data of an instrument as presented in this invention can further comprise: a coordinate system establishment means for establishing a two-dimensional coordinate system and aligning a center of the acquired current data image of the instrument to be read with an origin of the two-dimensional coordinate system; and a voice broadcast means for conducting voice broadcast for the current instrument data calculated by the third calculation means to avoid a need for a user to check results, which is more convenient.

As can be seen from the above analysis, the examples of this invention comprise controlling rotation of the current data image in a first direction and acquiring current projection values of a pointer of the instrument in a vertical direction from the current data image after acquiring a current data image from an instrument to be read; then, selecting a maximum projection value from the acquired projection values and determining a corresponding position of the pointer of the instrument as a position to be calculated; calculating a first rotation angle required by rotation of the pointer of the instrument to the position to be calculated; substituting the first rotation angle into a pre-stored first calculation formula and calculating a first angle between the pointer of the instrument and the position to be calculated; then, substituting the first angle into a formula of correspondence between a pre-stored angle between the pointer of the instrument and the position to be calculated and instrument graduations to calculate current instrument data of the instrument to be read. As can be seen, according to the present invention, an angle between a pointer of an instrument and a horizontal direction is calculated based on a feature of instrument denotation with a detailed head and a rough tail, to calculate instrument data, thus ensuring the accuracy of the resulting data and avoiding effects of deviation of the straight-line direction calculated by the Hough transform from the actual direction of the pointer of the instrument on instrument readings.

Further, as should be noted, relational terms such as first, second and the like with respect to each of the above examples are only used to distinguish one operation or means from another operation or means, without necessarily requiring or implying the existence of any such actual relationship or order between or among these means or operations.

Various examples of the present specification are described in a progressive manner; each of the examples emphasizes its difference from other examples; and the same or similar portions between the examples have reference to each other. Because of its correspondence with the method disclosed in the examples, the system disclosed in the examples are simply described, and for corresponding parts, please refer to the description on the method.

The previous description on the disclosed examples enables those skilled in the art to achieve or use this invention. Various modifications to these examples will be obvious to those skilled in the art, and the general principles defined herein may be realized in other examples without departing from the spirit or scope of the present invention. Accordingly, the present invention will not be limited to these examples shown herein, but should comply with the widest range consistent with the principles and novel features disclosed herein.

What is claimed is:

1. A method for detecting data of an instrument, characterized in that said method comprises:
acquiring a current data image from an instrument to be read;
controlling rotation of the current data image in a first direction and acquiring current projection values of a pointer of the instrument in a vertical direction from the current data image;
selecting a maximum projection value from all of acquired current projection values and determining a position where the pointer of the instrument has the maximum projection value in the vertical direction as a position to be calculated;
calculating a first rotation angle required by rotation of the pointer of the instrument to the position to be calculated in the first direction;
substituting the first rotation angle into a pre-stored first calculation formula and calculating a first angle between the pointer of the instrument and the position to be calculated; and
calculating current instrument data of the instrument to be read using correspondence between a pre-stored angle between the pointer of the instrument and the position to be calculated and instrument graduations.

2. The method as recited in claim 1, characterized in that the controlling rotation of the current data image in a first direction is particularly:
controlling rotation of the current data image in a clockwise or counterclockwise direction.

3. The method as recited in claim 2, characterized in that the position to be calculated is a horizontal position.

4. The method as recited in claim 3, characterized in that the first calculation formula is:
$${θ}_{I} = \{ \begin{matrix}{θ}_{A} , & {H}_{A} < \frac{w}{2} \\ {θ}_{A} + 180 , & {H}_{A} > \frac{w}{2}\end{matrix} ;$$
wherein w represents width of the current data image, θ_{I} represents an angle between the pointer of the instrument and a horizontal direction, and θ_{A} represents the first rotation angle.

5. The method as recited in claim 4, characterized in that the correspondence between a pre-stored angle between the pointer of the instrument and the position to be calculated and instrument graduations I(θ_{I}) is detailed as:
$$I ( {θ}_{I} ) = \frac{{I}_{max} - {I}_{min}}{{θ}_{max} - {θ}_{min}} {θ}_{I} + \frac{{I}_{min} {θ}_{max} - {I}_{max} {θ}_{min}}{{θ}_{max} - {θ}_{min}} ;$$
wherein Iₘₐₓ represents a maximum graduation of the instrument to be read, θₘₐₓ represents an angle of the pointer of the instrument at a position corresponding to the maximum graduation of the instrument to be read, Iₘᵢₙ represents a minimum graduation of the instrument to be read, and θₘᵢₙ represents an angle of the pointer of the instrument at a position corresponding to the minimum graduation of the instrument to be read.

6. The method as recited claim 1, characterized in that said method further comprises:
establishing a two-dimensional coordinate system and aligning a center of the acquired current data image of the instrument to be read with an origin of the two-dimensional coordinate system, prior to the controlling rotation of the current data image in a first direction.

7. A system for detecting data of an instrument, characterized in that said system comprises:
an acquisition means for acquiring a current data image from an instrument to be read;
a rotation control means for controlling rotation of the current data image in a first direction and acquiring current projection values of a pointer of the instrument in a vertical direction from the current data image;
a selection means for selecting a maximum projection value from all of acquired current projection values and determining a position where the pointer of the instrument has the maximum projection value in the vertical direction as a position to be calculated;
a first calculation means for calculating a first rotation angle required by rotation of the pointer of the instrument to the position to be calculated in the first direction;
a second calculation means for substituting the first rotation angle into a pre-stored first calculation formula and calculating a first angle between the pointer of the instrument and the position to be calculated; and
a third calculation means for calculating current instrument data of the instrument to be read using correspondence between a pre-stored angle between the pointer of the instrument and the position to be calculated and instrument graduations.

8. The system as recited in claim 7, characterized in that the rotation control means comprises:
a clockwise rotation control module for controlling rotation of the current data image in a clockwise direction; and
a counterclockwise rotation control module for controlling rotation of the current data image in a counterclockwise direction.

9. The system as recited in claim 8, characterized in that the system further comprises:
a coordinate system establishment means for establishing a two-dimensional coordinate system and aligning a center of the acquired current data image of the instrument to be read with an origin of the two-dimensional coordinate system.

10. The system as recited in claim 7, characterized in that the system further comprises:
a voice broadcast means for conducting voice broadcast for the current instrument data calculated by the third calculation means.
